(19) United States
(12) Patent Application Publication
(10) Pub. No.: US 2023/0135357 A1
(43) Pub. Date: May 4, 2023

(54) DRIVING WAVEFORMS FOR REFLECTIVE DISPLAYS AND REFLECTIVE DISPLAYS USING THE SAME

(71) Applicant: SOLCHROMA TECHNOLOGIES, INC., Somerville, MA (US)

(72) Inventors: Matthew APREA, Somerville, MA (US); Samuel SHIAN, Somerville, MA (US); Roger DIEBOLD, Somerville, MA (US)

(21) Appl. No.: 17/912,330

(22) PCT Filed: Mar. 16, 2021
(86) PCT No.: PCT/US2021/022625

§ 371 Date: Sep. 16, 2022

Related U.S. Application Data
(60) Provisional application No. 62/990,245, filed on Mar. 16, 2020.

(51) Int. Cl. G09G 3/34; G09G 3/20; G09G 3/36

(52) U.S. Cl. CPC G09G 3/344; G09G 3/2003; G09G 3/3486; G09G 3/3493; G09G 3/3681; G09G 3/3692; G09G 2300/0443; G09G 2300/0452

(57) ABSTRACT

Methods of driving a display matrix and matrix waveforms for driving said display matrix between color states are provided. Additionally, reflective displays incorporating a waveform generator to generate a waveform to drive the display from a first color state to a second color state are also provided. The reflective displays can include a display matrix having a plurality of row electrodes and a plurality of column electrodes; a plurality of display elements with an actuator to modify a color of the display element upon actuation; a fixed voltage source; and a waveform generator for determining an amount of time to apply the fixed voltage to each display element to drive the display element from a first color state to a second color state. The reflective display can be based on moving colored inks into and out of the viewable area of each display element to control the color.

### CROSS-REFERENCE TO RELATED APPLICATIONS

This application claims priority to and the benefit of co-pending U.S. provisional patent application entitled “DRIVING WAVEFORMS FOR REFLECTIVE DISPLAYS AND REFLECTIVE DISPLAYS USING THE SAME,” having Ser. No. 62/990,245, filed Mar. 16, 2020, the contents of which are incorporated by reference herein.

### STATEMENT REGARDING FEDERALLY SPONSORED RESEARCH OR DEVELOPMENT

This invention was made with government support under Grant No. 1660204 awarded by the National Science Foundation. The government has certain rights in the invention.

### TECHNICAL FIELD

The present disclosure generally relates to displays and display drivers and in particular to displays and display drivers for reflective displays based on moving one or more colored inks into and out of a viewable area of the display.

### BACKGROUND

Reflective displays offer paper- and print-like high contrast ratio and readability in bright sunlight. Furthermore, the low power consumption makes them an attractive commercial signage proposition. Some reflective display technologies utilize a colored fluid, such as an ink, which is configured to be moved between a reflector and a viewer of the display. Such a reflective display may rely on several actuator technologies. In such displays, a particular color is achieved by applying a waveform to the pixels of the display. Such waveform typically includes a plurality of voltage levels that are sequentially applied to a pixel, e.g. +15V, 0V, 0V, +15V etc. The actuators will move according to the applied waveform. Based on the applied waveform and on the state of the pixel prior to applying the waveform, e.g. the previous image, a particular color or shade of gray may be obtained. Other reflective display technologies, such as those that may employ dielectric elastomer actuators as the primary means of effecting color change, require voltages that are on the order of 100V or 1000V for normal operation. Typical display driver circuits cannot accommodate such voltage levels because of concerns over gate dielectric resistance to electrical breakdown or close spacing of electrically conductive pathways that may experience flashover at such voltage levels. Beyond surviving normal operation at such high voltage levels, it is necessary to have sufficient speed to transition between low and high states for the coupled display system to achieve desired color state transitions on meaningful time scales. A mechanism is therefore necessary to control the actuator state and position precisely and repeatably to generate the desired color state on the display.

There remains a need for improved display drivers for reflective displays that overcome the aforementioned deficiencies.

### SUMMARY

In various aspects, this disclosure provides methods of driving a display, in particular a reflective display, that overcome one or more of the aforementioned deficiencies of previous methods when applied to reflective displays. Waveforms and waveform generators for driving a display from a first display state to a second display state are provided. Additionally, displays incorporating the methods and waveform generators are also provided.

In some aspects described herein, a method is provided for driving a display matrix for driving a reflective display from a first display state to a second display state. The reflective display can include a plurality of display elements, wherein each of the display elements in the plurality of display elements has an actuator configured to modify a color of the display element upon actuation. The display matrix can have a plurality of row electrodes and a plurality of column electrodes, wherein each of the display elements in the plurality of display elements is coupled to a single row electrode in the plurality of row electrodes and a single column electrode in the plurality of column electrodes. The method for driving the display matrix can include (i) for each display element in the plurality of display elements, applying a fixed voltage across the actuator for an amount of time to drive the display element from a first color state to a second color state; and repeating step (i) for each display element in the plurality of display elements to drive the display from the first display state to a second display state. Displays capable of carrying out the method are also provided.

In some aspects described herein, a method is provided for driving a reflective display from a first display state to a second display state, the method including generating a waveform for each frame in a number of frames, wherein the waveform represents a drive voltage to be applied to an actuator in each of one or more subpixels. The method can also include applying the drive voltage to each of the actuators according to the waveform, wherein the subpixels form a plurality of pixels and applying the drive voltage to each of the actuators drives the pixels in the plurality of pixels from a first color state to an intermediate color state. By driving each of the pixels over a number of frames, the method can include transforming the display from the first color state to the second color state. The drive voltage for an actuator commanded by one frame of the waveform can be the same or different from the drive voltage commanded for that same actuator by the next frame. Displays capable of carrying out the method are also provided.

In some aspects described herein, a reflective display is provided having (i) a plurality of pixels, each of the pixels in the plurality of pixels having one or more subpixels and an actuator for independently driving each of the one or more subpixels; (ii) a timing generator that divides a display update time into a number of frames based at least in part on a number of rows and a number of columns in the plurality of pixels; and (iii) a waveform generator that generates a waveform for each frame in a number of frames, wherein the waveform represents a drive time for a drive voltage to be applied to an actuator in each of one or more subpixels. Applying the drive voltage to the actuators in each of the subpixels according to the waveform can drive the display from a first display state to a second display state.

In some aspects described herein, a reflective display is provided having a display matrix with a plurality of row electrodes and a plurality of column electrodes; a plurality of display elements, wherein each of the display elements in the plurality of display elements comprise an actuator configured to modify a color of the display element upon actuation, and wherein each of the display elements in the plurality of display elements is coupled to a single row electrode in the plurality of row electrodes and a single column electrode in the plurality of column electrodes; a voltage source for applying a fixed voltage to each of the row electrodes and column electrodes in the plurality of electrodes; and a waveform generator for determining an amount of time to apply the fixed voltage to each display element to drive the display element from a first color state to a second color state.

Other systems, methods, features, and advantages of reflective displays will be or become apparent to one with skilled in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Further aspects of the present disclosure will be readily appreciated upon review of the detailed description of its various embodiments, described below, when taken in conjunction with the accompanying drawings.

FIG. 1 is a graph of Maxwell pressure (Y axis) as a function of applied electric field (X axis) in an exemplary dielectric elastomer actuator illustrating its nonlinearity.

FIG. 2 is an exemplary waveform structure for a present state independent waveform.

FIG. 3 is an exemplary waveform structure for a present state dependent waveform.

FIG. 4 is an exemplary frame row timing sequence.

FIG. 5 is an exemplary timing sequence demonstrating pulse width modulation (PWM).

FIG. 6 is an exemplary temperature compensated pulse width modulation (PWM) waveform file structure.

FIG. 7 is an exemplary binary waveform file format.

FIG. 8 is an exemplary memory structure for state dependent waveform.

FIG. 9 is an example of a layout for a passive matrix display having a grid of eight rows and ten columns.

### DETAILED DESCRIPTION

In various aspects, waveform generators and waveform algorithms for reflective displays are provided. The waveforms can be used, for example, in a reflective display based on moving colored inks into and out of the viewable area of each pixel in the display. Such displays are described, for example, in PCT/US2019/058196. The displays can in some instances incorporate pixels having a nonlinear pixel actuation means. Applicants have found that displays and display drivers having nonlinear pixel actuation can offer several advantages, including eliminating crosstalk between pixels when passive matrix addressing is used.

Some reflective display technologies utilize a colored fluid, such as an ink, which is configured to be moved between a reservoir hidden from view and a directly viewable chamber located in front of a reflector. By moving fluid around within the display device, an amount of colored fluid between the viewer and the reflector can be changed, thereby changing an amount of color visible to the viewer. For instance, some fluidic devices move fluid between cavities through channels or flow paths using an external energy source that moves the fluid from a low energy state to a high energy state.

Such a reflective display may rely on several actuator technologies such as having piezoelectric, electrostrictive, electromagnetic, electrostatic, hydraulic, thermal, chemical or pneumatic origins. However, reflective displays can also suffer from effects due to crosstalk between adjacent pixels. Crosstalk occurs when activating one pixel produces unintended changes in nearby pixels. Such artifacts can arise, for example, from the electrode resistance, pixel leakage current, or the location of faulty pixels. Applicants have determined that, by using nonlinear actuation means for the pixels can provide certain benefits by reducing crosstalk in a passive matrix reflective display. In principle, any nonlinear actuator exhibiting sufficient nonlinear response to applied electric field can be used. However, it can be preferable to use an actuator based on electroactive polymers, specifically dielectric elastomers, because of the force displacement characteristics, cost, weight, and driving requirements. Under applied electric field, dielectric elastomers deform non-linearly according to the non-linear elasticity of the elastomeric material and the non-linear Maxwell pressure. The non-linear elasticity of elastomers originates from a molecular structure where different amounts of strain drives different molecular network responses, such as but not limited to chain uncurling, sliding, network entanglements. The Maxwell pressure is generated from an applied electrical field over the dielectric elastomer, in which the magnitude of stress is proportional to the dielectric constant of the elastomer and the applied electric field squared. This nonlinearity in response is desirable when driving such actuator elements in an array via passive matrix addressing as crosstalk between elements is minimized. Therefore, in various aspects, reflective displays are provided having dielectric elastomer actuators, and driving mechanisms described herein are provided. In some aspects, the nonlinearity of the response is increased by placing diodes in series with the nonlinear actuator, thereby decreasing the crosstalk in a passive matrix configuration.

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting. The skilled artisan will recognize many variants and adaptations of the embodiments described herein. These variants and adaptations are intended to be included in the teachings of this disclosure.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant specification should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

Although any methods and materials similar or equivalent to those described herein can also be used in the practice or testing of the present disclosure, the preferred methods and materials are now described. Functions or constructions well-known in the art may not be described in detail for brevity and/or clarity. Embodiments of the present disclosure will employ, unless otherwise indicated, techniques of electrical engineering, mechanical engineering, chemistry and material science, computer science, and the like, which are within the skill of the art. Such techniques are explained fully in the literature.

It should be noted that ratios, concentrations, amounts, and other numerical data can be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to about 5%” should be interpreted to include not only the explicitly recited values of about 0.1% to about 5%, but also include individual values (e.g., 1%, 2%, 3%, and 4%) and the sub-ranges (e.g., 0.5%, 1.1%, 2.2%, 3.3%, and 4.4%) within the indicated range. Where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In some embodiments, the term “about” can include traditional rounding according to significant figures of the numerical value. In addition, the phrase “about ‘x’ to ‘y’”, where ‘x’ and ‘y’ are numerical values, includes “about ‘x’ to about ‘y’”.

In some instances, units may be used herein that are non-metric or non-SI units. Such units may be, for instance, in U.S. Customary Measures, e.g., as set forth by the National Institute of Standards and Technology, Department of Commerce, United States of America in publications such as NIST HB 44, NIST HB 133, NIST SP 811, NIST SP 1038, NBS Miscellaneous Publication 214, and the like. The units in U.S. Customary Measures are understood to include equivalent dimensions in metric and other units (e.g., a dimension disclosed as “1 inch” is intended to mean an equivalent dimension of “2.5 cm”; a unit disclosed as “1 pcf” is intended to mean an equivalent dimension of 0.157 kN/m³; or a unit disclosed 100° F. is intended to mean an equivalent dimension of 37.8° C.; and the like) as understood by a person of ordinary skill in the art.

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

The articles “a” and “an,” as used herein, mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

Further, some actions are described as taken by a “user.” It should be appreciated that a “user” need not be a single individual, and that in some aspects, actions attributable to a “user” can be performed by a team of individuals and/or an individual in combination with computer-assisted tools or other mechanisms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Following below are more detailed descriptions of various concepts related to, and aspects of, techniques for producing a fluidic actuator. It should be appreciated that various aspects described herein can be implemented in any of numerous ways. Examples of specific implementations are provided herein for illustrative purposes only. In addition, the various features described in the aspects below may be used alone or in any combination, and are not limited to the combinations explicitly described herein.

Reflective Displays

Reflective displays have several advantages already discussed above. A variety of reflective display technologies have been developed, primarily using liquid crystalline displays that are complex and costly to produce. Applicants have developed a reflective display technology based on hydraulic pumps, that when actuated move colored ink from reservoirs behind a pixel surface into separate, viewable color filter chambers. The technology is described, for example, in PCT/US2019/058196, the contents of which are incorporated in their entirety as if fully disclosed herein.

The reflective display can be configured to alter an optical property by moving an amount of a first fluid through which external light can pass, the display device including a fluidic display unit having at least a first cavity containing a first fluid, the first fluid movable within the first cavity by varying an amount of pressure on the first cavity; and an actuator mechanically coupled to the fluid-filled cavity of the fluidic display unit, the actuator being a nonlinear actuator as described herein.

In various aspects, display devices are provided that have as a component an actuator. Suitable actuators can include those described herein. In some aspects, the actuator is a dielectric elastomer exhibiting nonlinear response. In an exemplary aspect, the actuator has a first cavity containing fluid and bounded at least in part by a first elastomer; a second cavity containing fluid and bounded at least in by part by a second elastomer; a channel connecting the first cavity to the second cavity and through which fluid can flow; and a valve configured to be electrically operated into an open state or a closed state and thereby allow or block flow of the fluid through the channel, respectively, wherein maintaining the valve in the closed state requires less electrical power than maintaining the valve in the open state.

In an exemplary aspect, a display device is provided that is configured to alter an optical property by moving an amount of a first fluid through which external light can pass, the display device comprising: a fluidic display unit comprising at least a first cavity comprising a first fluid, the first fluid movable within the first cavity by varying an amount of pressure on the first cavity; and a nonlinear actuator for varying the amount of pressure on the first cavity of the fluidic display unit, wherein varying the pressure causes movement of the first fluid within the fluidic display unit, thereby altering the optical property of the display. The nonlinear actuator can include any of the exemplary nonlinear actuators described herein.

This disclosure provides waveforms and waveform generators for driving one or more actuators in a reflective display. In some aspects, the actuator can produce a pressure at a surface of the actuator that is capable of being adjusted and, once adjusted to a desired amount, held at that pressure using little to no power. By mechanically coupling a fluidic display unit to such a surface, the actuator can be operated to push against a surface of the fluidic display unit with a varying amount of pressure, thereby providing a level of control over the location of fluid within the fluidic display unit.

According to some aspects, an optical property that can be altered by movement of fluid within the fluidic display unit can include alterations to changes in the color of light reflected from the display unit. As one example, such alterations can include alterations to changes in color produced when white light reflects from the display unit. That is, by arranging fluid within display unit in a first manner, it can be that white light reflecting from the display unit is emitted with a first non-white color (e.g., blue), and by arranging fluid within the display unit in a second manner, it can be that white light reflecting from the display unit is instead emitted with a second non-white color (e.g., red). In some aspects, fluidic display unit can include inks, pigments and/or other color agents that can be arranged within the fluidic display unit to alter how the color of reflected light is affected by such reflection. The arrangement of the inks, pigments, or other color agents can be altered by the movement of the fluid in the fluidic display unit caused by a nonlinear actuator described herein.

As discussed above, a nonlinear actuator is arranged and configured to apply a variable force to the fluidic display unit. In some aspects, the nonlinear actuator is configured to apply a mechanical force to the fluidic display unit. The variable force can be applied directly from the nonlinear actuator to the fluidic display unit (e.g., the actuator can be in physical contact with the display unit) and/or can be applied via intermediate mechanical elements.

The reflective displays include electroactive polymer actuators for pumping colored inks into and out of each sub-pixel in a controllable fashion. In principle, any number of actuation means can be employed in the reflective displays described herein. The reflective display may rely on several actuator technologies such as having piezoelectric, electrostrictive, electromagnetic, electrostatic, hydraulic, chemical, thermal or pneumatic origins. In some aspects, the display can include actuators based on electroactive polymers, specifically dielectric elastomers (DEs), because of the force displacement characteristics, cost, weight, and driving requirements.

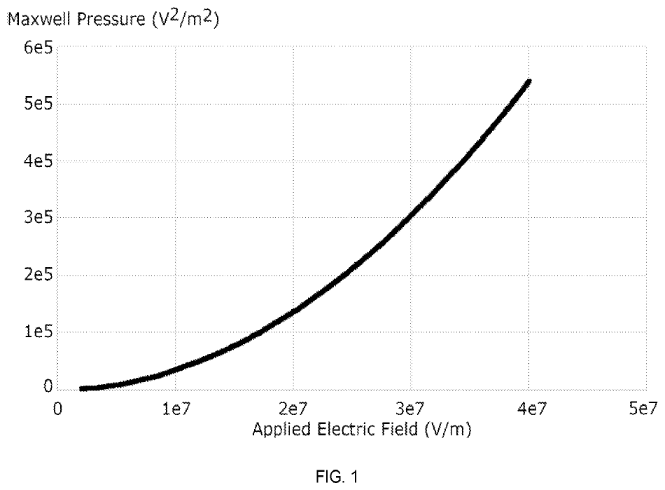

DEs are deformable capacitor devices that store and convert electrical energy (E_{Q}) into mechanical energy, both to itself stored as elastic energy (E_{Y}) and to perform external work (W): The electrical energy is converted to mechanical work through Maxwell Stress or Maxwell Pressure that is proportional to the dielectric constant of the elastomer and the applied electric field squared (see e.g. FIG. 1). Ignoring thermal and electromagnetic effects, the energy equilibrium within the elastomer can be written as: E_{Q}=E_{Y}+W. The external work W is known as useful actuation used to pump fluids in a reflective display. As can be seen above, the amount of actuation is proportional to the stored electrical energy, which can be written as E_{Q}=Q²/2C, where Q is the amount of stored charge and C is the instantaneous capacitance of the DE. When the input voltage is constant, the amount of charge can be varied by varying the charging time: Q=∫idt=īΔt₁, where i and t are the charging current and the charging time, respectively.

The variation of charge as function of time is the basis of PWM driving method, in which a grey scale pixel state can be achieved by varying the width of PWM pulse, Δt₁. In an ideal capacitor with zero charge leakage, the charging current will be stopped once the required amount of charge, Q, is achieved. Thereby a constant grey scale will be maintained.

However, in practice, DE actuators are a leaky capacitor in which charge will leak at a rate faster than the time required to maintain an actuated state. In this situation, a charging current has to be supplied at a rate such that the charge input is equal to the charge leakage rate.

Qₗₑₐₖ=∫iₗₑₐₖdt=īΔt₂

From PWM standpoint, the charge leakage can be compensated using a charging time, Δt₂, which is lower than Δt₁.

Since the relation of charge leakage is non-linear with respect to charging of the DE (the leakage current exponentially increases with respect to the electric field and the amount of actuation strain), one can apply a constant Δt₂ to achieve grey scale. However, since Δt₂ is smaller than Δt₁, it may take a significant amount of cycle time before charge equilibrium occurs. The cycle will be even longer for DE systems having lower leakage current. This method may not be practical for reflective display applications, where image refresh rates may need to be relatively fast.

To achieve faster refresh rates, a waveform may have two stages; the first stage is to achieve the grey level and the second stage is to maintain the grey level. The first stage applies the first few PWM pulses such as anywhere from, but not limited to, 1 to 100 PWM cycles. The second stage applies for an infinite amount of time or for as long of a time as needed to maintain the currently displayed image before a new image is displayed, or a separate mechanism to impart bistability or multistability is activated. For each grey level, the waveform table may consist of two values, Δt₁ and Δt₂. Alternatively, when the relationship between Δt₁ and Δt₂ follows an empirical relation, e.g., linear, the waveform table may include only one value, Δt₁, and consequently Δt₂ is calculated from their empirical relationship.

The displays can include any number of actuators necessary to drive the color change. However, in typical full-color displays three actuators will be used per pixel—one each for Cyan, Magenta, and Yellow ink layers. A waveform look-up-table (LUT) can be defined to represent the sequence of drive pulses for each ink actuator necessary to move the display from an all-black, all-white or any-color state to the desired color state.

Each of the subpixels can in include a valve to allow the subpixel to maintain color in an undriven state. The valves can be passive valves, e.g. a unidirectional valve that allows ink to flow into the viewable area readily but only allows the ink to flow out at certain rates of actuations. For such passive valves in order to open the valve to drain a reservoir a single or multi-frame pulse can be used to open the valve (in essence moving ink in the opposite direction filling the reservoir), before the waveform allows the reservoir to drain and fill the active area. This passive valve closing or opening scheme may rely on the rate of actuator charging or discharging to ‘quickly’ unseal or seal the valve relative to the typical flow rate of fluid in the valving apparatus. The sub-pixels can also include active valves that are controlled via an applied voltage. Such valving may confer the ability of the sub-pixel to become multistable in its operation.

In some aspects, a reflective display is provided including a plurality of pixels, each of the pixels in the plurality of pixels having one or more subpixels and an actuator for independently driving each of the one or more subpixels. The subpixels can be, for example, Cyan, Magenta, Yellow subpixels that combine to define a color state of the pixel. The subpixels can also sometimes be referred to more generally as display elements. The displays can include a plurality of display elements or subpixels which can be arranged to form a plurality of pixels.

The image on the display can be updated by driving the display from a first display state to a second display state, thereby updating the image. This can correspond to frames in a video or to simply changing a relatively static image on a display. For example, reflective displays offer several advantages for signage in that they can be relatively low power compared to emissive displays while allowing for periodic updating of the image displayed. When not being updated, the display can be in a zero or low-power state while still maintaining the image or display state of the display.

In various aspects, the display includes a timing generator that divides a display update time into a number of frames based at least in part on a number of rows and a number of columns in the plurality of pixels. A waveform generator can generate a waveform for each frame in a number of frames, wherein the waveform represents a drive time for a drive voltage to be applied to an actuator in each of one or more subpixels, wherein applying the drive voltage to the actuators in each of the subpixels according to the waveform drives the display from a first display state to a second display state.

The displays can include a voltage source for generating the drive voltage. In order to achieve fine control of the actuator (and therefore the amount of ink driven to the front plane and thus pixel color) with a single drive voltage, it is necessary to modulate the amount of time that an actuator is driven. This can be accomplished by either modifying the duty cycle of a drive pulse or by modulating the pixel drive state over a sequence of frames in active matrix parlance. Both effect a change in the amount of time that a pixel is driven.

In some aspects, the drive voltage is switched between a zero voltage state and a high voltage state, wherein a difference between the zero voltage state and the high voltage state is greater than a threshold voltage necessary to actuate an actuator. In some aspects, the voltage source is configured to apply a scanning voltage to a row electrode for an amount of time equal to a scan time, the amount of time the scanning voltage is applied to the row electrode being a frame. In some aspects, the voltage source is configured to apply a selection voltage to the column electrode corresponding to each display element for the amount of time to drive the display element from the first color state to the second color state.

The reflective displays described herein can in principle be built using an active matrix control, a passive matrix control, or some other type of control. However, passive matrix control is preferred when the important characteristics include low cost and simplicity to manufacture. Because the actuators are used to drive the pumping of the ink as opposed to directly stimulating light emission as in the LEDs, the lifetimes are not significantly impacted by operating in passive matrix configuration. In some aspects, this is because the dielectric elastomer actuators exhibit charge retention characteristics, which consequently enables the DE to hold its actuation state between scanning cycles without the use of excessive voltage compensation, particularly for relatively large passive matrix array addressing.

A representative passive matrix display configuration is highlighted in FIG. 9 for a grid of eight rows and ten columns. A row is selected by applying a high voltage (+V) while all other rows floated with a high-impedance state. An actuator is energized by driving the column address to 0V, an actuator is allowed to relax by floating the column (high-impedance state). The voltage difference between +V and 0V on driven lines is greater than the threshold voltage necessary to actuate the electroactive polymer, and therefore only a single voltage is necessary.

In some aspects, each frame is divided into a number of subframes, each subframe in the number of subframes corresponding to a period of time during which a row in the number of rows is in a high voltage state. For each subframe, the drive time for the actuator in each subpixel of that row is determined by a percentage of the subframe that a column corresponding to the subpixel is in a zero voltage state. This allows the period of time during which a row is in a high voltage state to be the same for each row in the number of rows.

In the various displays described herein, methods are applied to generate waveforms or driving signals to drive the display from a first display state to a second display state. This can include methods, waveforms, and waveform generators for reflective displays described below.

Waveforms and Waveform Generators for Reflective Displays

The reflective displays described herein will include a waveform generator for generating the waveform to drive the images on the display, which can be based on passive matrix or active matrix technology.

In some aspects, methods include for each display element in the plurality of display elements, applying a fixed voltage across the actuator for an amount of time to drive the display element from a first color state to a second color state; and repeating this step for each display element in the plurality of display elements to drive the display from the first display state to a second display state.

The method can include, for a row electrode in the plurality of row electrodes, applying the scanning voltage to the row electrode for an amount of time equal to a line scan time, the cumulative time the scanning voltage is applied to all row electrodes being a frame. The methods can also include, for each display element being updated in the frame, applying a selection voltage to the column electrode corresponding to the display element for the amount of time to drive the display element from the first color state to the second color state. By repeating these steps for each row, the methods can drive the display from the first display state to a second display state.

In some aspects, wherein each frame is divided into a number of subframes, each subframe in the number of subframes corresponding to a period of time during which a row in the number of rows is in a high voltage state. For each subframe, the drive time for the actuator in each subpixel of that row is determined by a percentage of the subframe that a column corresponding to the subpixel is in a zero voltage state. This allows the period of time during which a row is in a high voltage state to be the same for each row in the number of rows.

In some aspects, the methods include generating a waveform for each frame in a number of frames, wherein the waveform represents a drive time for a drive voltage to be applied to an actuator in each of one or more subpixels and then applying the drive voltage to each of the actuators according to the waveform, wherein the subpixels form a plurality of pixels and applying the drive voltage to each of the actuators drives the pixels in the plurality of pixels from a first color state to a second color state. By driving each of the pixels, the method transforms the display from the first color state to the second color state.

In some aspects, the methods include generating a waveform for each frame in a number of frames, wherein the waveform represents a drive voltage (+V or 0V) to be applied to an actuator in each of one or more subpixels and then applying the drive voltage to each of the actuators according to the waveform, wherein the subpixels form a plurality of pixels and applying the drive voltage to each of the actuators drives the pixels in the plurality of pixels from a first color state to an intermediate color state; wherein driving each of the pixels over a number of frames, the method transforms the display from the first color state to the second color state; wherein the drive voltage for an actuator commanded by one frame of the waveform may differ from the drive voltage commanded for that same actuator by the next frame.

In some aspects, each frame comprises a number of subframes, each subframe in the number of subframes corresponding to a period of time during which a row in the number of rows is in a high voltage state; wherein, for each subframe, the drive time for the actuator in each subpixel of that row is determined by a percentage of the subframe that a column corresponding to the subpixel is in a zero voltage state.

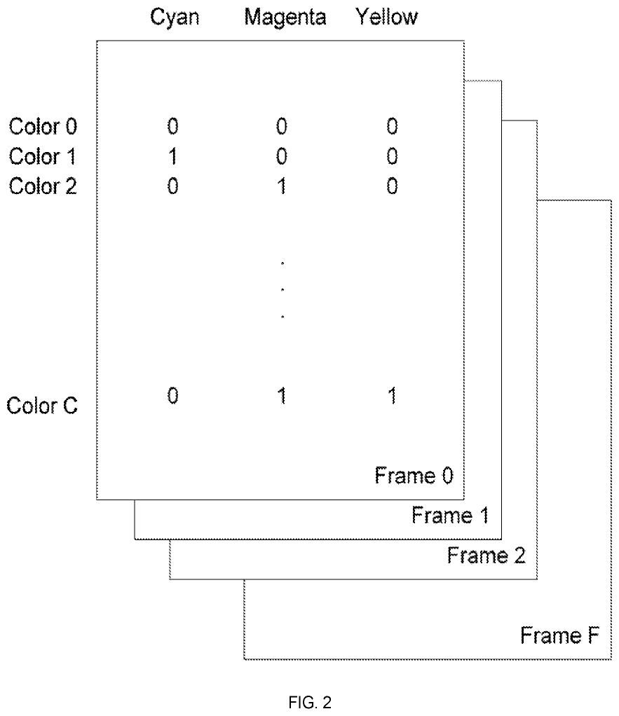

In some aspects, the waveform needed to drive the display from the first display state to the second display state is dependent only on the second display state. FIG. 2 illustrates an exemplary waveform structure for such a display, where Colors 0-C as the display output, with each sub-pixel actuator independently driving an amount of Cyan, Magenta, or Yellow ink into the viewable pixel cavity. This exemplary configuration requires that to achieve Color 1 the Cyan actuator must be driven to state 1 while the Magenta and Yellow actuators must be driven to State 0 in Frame 0. Future frames 1-F may require different drive values for each actuator to achieve Color 1 over the entire display update time. To achieve Color 2 the Cyan and Yellow actuators must be driven to state 0 while the Magenta actuator must be driven to state 1 in Frame 0.

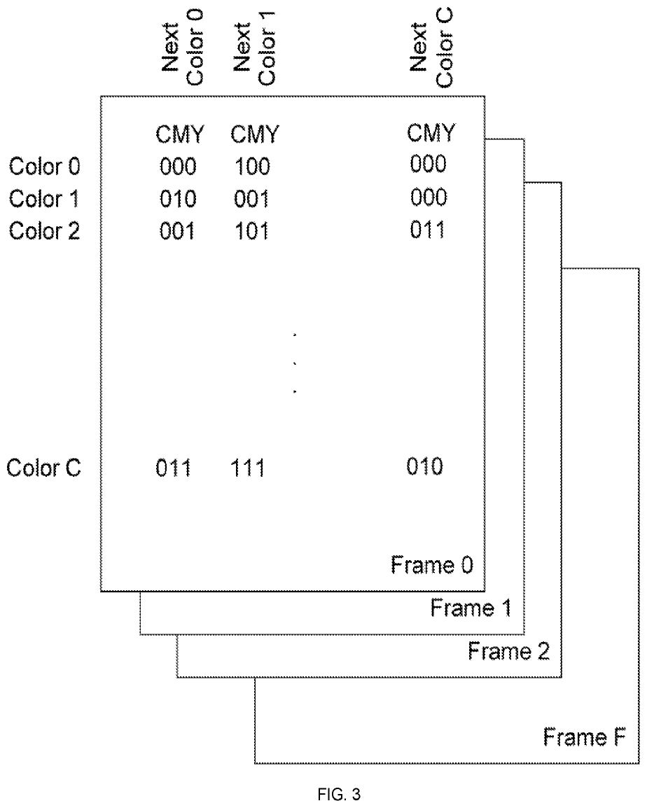

In some aspects, the display elements have state dependence such that the selection time to drive a display element from a first color state to a second color state is dependent upon the first color state. This can happen, for example, in some electroactive polymer displays that may have state dependence—the transition path to the next color state depends upon the present color state. It can then be that the waveform needed to drive the display from the first display state to the second display state includes drive times based upon both the first display state and the second display state. FIG. 3 depicts an example waveform structure that accounts for present state dependence. Here the present state is encoded in the address row, and the next state is encoded in the address column. To achieve next color C from present color 2 the Cyan actuator must be driven to state 0 while the Magenta and Yellow actuators must be driven to state 1.

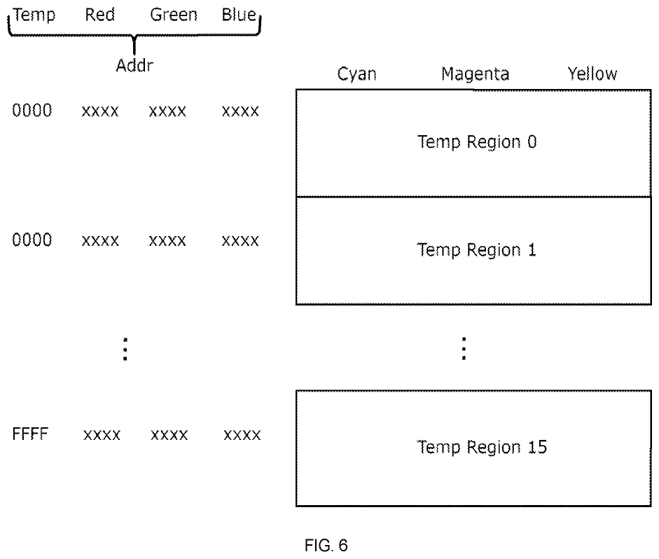

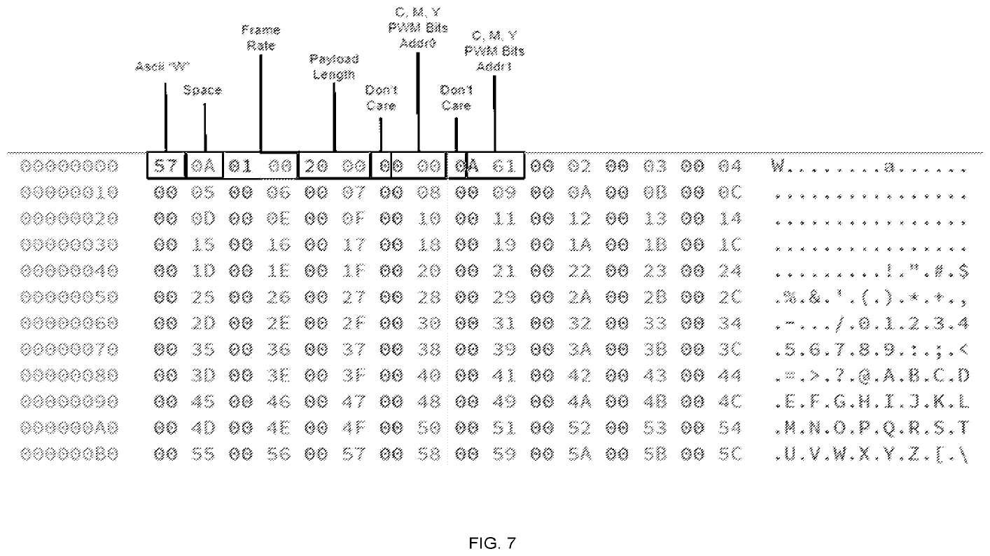

In some aspects, the selection time to drive a display element from a first color state to a second color state is dependent upon an ambient temperature of the display, e.g. the actuator, and the ink transfer responses can be temperature dependent. In such displays, a waveform needed to drive the display from the first display state to the second display state can include drive times based upon the ambient temperature. An example temperature structure is shown in FIG. 6, where 4-bits are reserved to specify temperature which allows for as many as 16 temperature ranges. Temperature ranges must not necessarily be of equal size. In a similar manner, selection time may be dependent upon an atmospheric pressure or ambient humidity. Pressure or humidity may factor into the waveform selection in a similar manner to temperature.

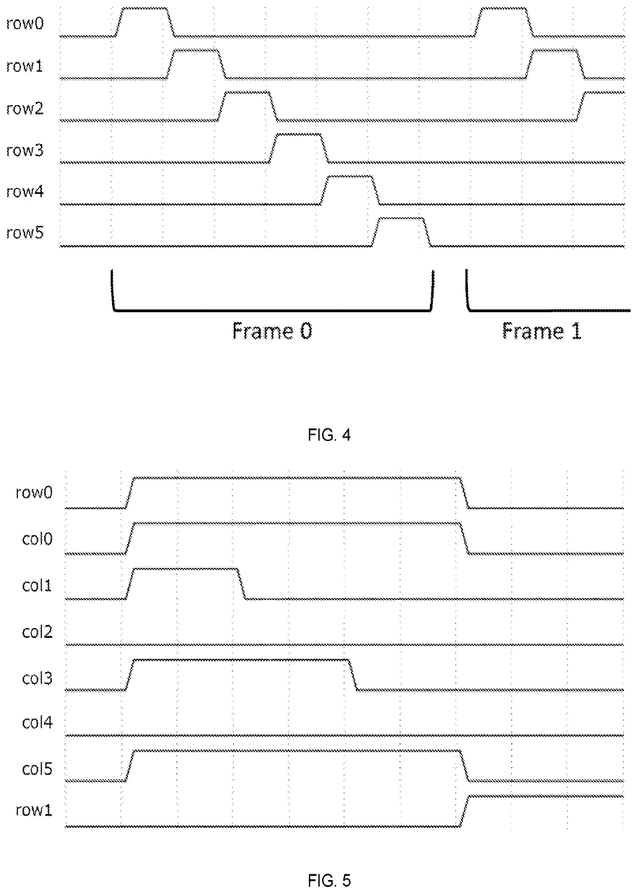

In some aspects, a display drive scheme may be implemented that utilizes slower row activation sequence timing while leveraging Pulse Width Modulation (PWM) to vary each column's “on” pulse which allows the amount of actuation to be varied. As shown in FIGS. 4-5 rows are turned “on” sequentially as before with a positive voltage pulse. Column “on” times may then be varied between full-on, full-off or somewhere in between. FIGS. 4-5 illustrate PWM-based timing. In such instances, the amount of time each display element is selected is varied by pulse width modulation to apply the selection voltage for the amount of time to drive each display element from each display element's first color state to each display element's second color state.

FIG. 5 depicts PWM where rows are addressed sequentially (e.g. in the example row0 is driven followed by row1), and the column “on” times are varied between on for the full row time, off for the full row time, or anything between. For example, FIG. 5 depicts col0 on for a full row scan time, coil on for a partial row scan time, and col2 off for a full row scan time.

A waveform for this system may need to translate an RGB-encoded image into CMY PWM drive signals for each pixel. A waveform structure for such a system might look as shown FIG. 6. In this example images are received in 12-bit RGB format with 4-bits per channel, four bits of temperature, pressure, and humidity information are then pre-pended to form a 16-bit word that may then act as an address into a LUT. The output of the LUT may be anywhere from a 6-bit word that encodes three 2-bit PWM drive values (one each for Cyan, Magenta and Yellow actuators) up to a 24-bit word that encodes three 8-bit PWM values or greater if system memory allows. These CMY PWM drive values are used to indicate the percentage of the row scan time that a column is “on”. For example, in a 12-bit system with three 4-bit PWM words per channel a value of 0xF indicates a 100% “on” time and 0x0 indicates a 0% “on” time encoded in 16 time increments. This process is repeated for the next frame and for each successive frame for the duration of the drive time. In this operation mode the same drive scheme is used for every frame. Where the 4-bits of temperature, pressure, and humidity information are pre-pended to the most significant bit of the waveform address, these act to define distinct temperature, pressure, and humidity regions as shown in FIG. 6.

A combination of multiple frames and PWM waveform structure may be used to allow accurate color representation on a reflective display.

The display elements can include a valve to maintain the color state of the display element. For passive valves, in order to open the valve to drain a reservoir, a single or multi-frame pulse can be used to open the valve (in essence moving ink in the opposite direction filling the reservoir), before the waveform allows the reservoir to drain and fill the active area. Here the first frame of the waveform may be structured to drive the actuator in one direction to open the valve and in the next frame the waveform may command the actuator to drive in the opposite direction to achieve the desired colored state. The last frame in the waveform may be structured to drive the actuator in the opposite direction to that of opening to seal the valve and effectively retain the desired and final actuator position, thus the corresponding ink level viewable to the observer, with minimal or no power applied to the actuator. This passive valve closing or opening scheme may rely on the rate of actuator charging or discharging to ‘quickly’ unseal or seal the valve relative to the typical flow rate of fluid in the valving apparatus.

Display modules constructed with an actively controlled valve can have a waveform that uses both the present state and next state to control the display. In order to affect direct state to state transitions (rather than state->black->state or state->white->state transitions) the controller must drive the actuator to the previous state before opening the valve and driving the display to the next state. Drive state A, close valve, turn power off, hold state, turn power on, drive state A, open valve, drive state B, close valve, turn power off . . . .

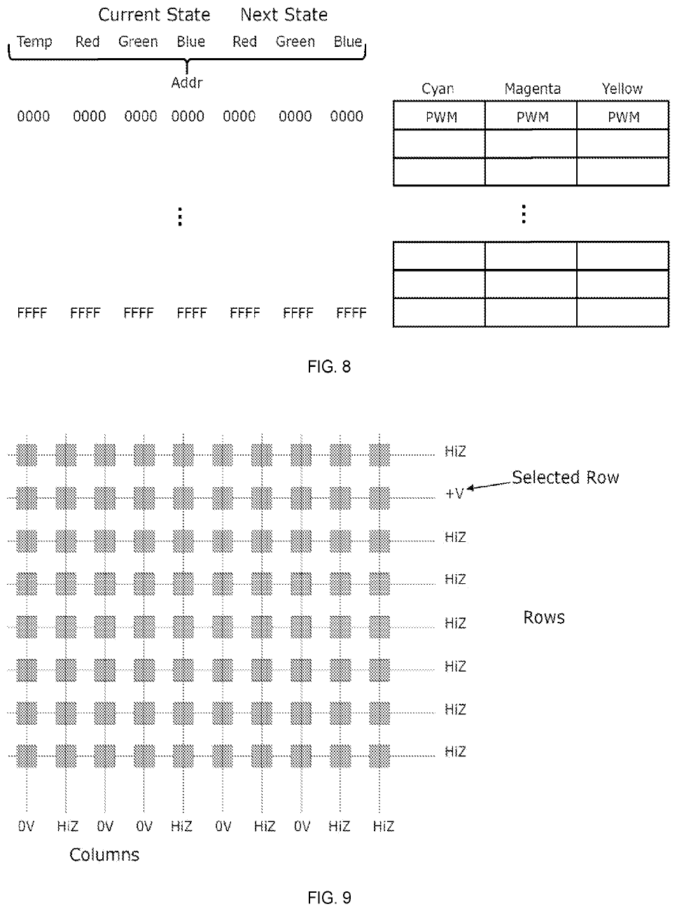

For displays outfitted with a valve, the framebuffer memory can be structured in such a way to allow both the present and next image states to be stored, and used as an address into the waveform LUT (see FIG. 8).

Another aspect of the disclosure is the use of machine learning algorithms to generate waveforms for display state transitions. A supervised or unsupervised algorithm may be used to accomplish this goal. For the case of a supervised machine learning algorithm, optical data may be captured for each of a number of discrete display drive states. For instance, if there are N-display drive frames between a white state and a fully saturated colored state. Images may be captured after each of N frames that the display is driven. This may be repeated for each color (Cyan, Magenta, Yellow), and may be used as an input to train a machine learning algorithm. Using techniques such as Support Vector Machines, Discriminant Analysis, Naive Bayes, Decision Tree, Bagged and Boosted Decision Trees and Nearest Neighbor. The algorithm may then be allowed to predict the best (fastest, most accurate, least cross-talk) path to every color using techniques such as Linear and non-Linear Regression, Generalized Linear Model, Support Vector Machine Regression, Gaussian Process Regression Model, Ensemble Methods, Decision Trees and Neural Networks on the collected data sets.

Aspects of the Disclosure

The present disclosure will be better understood upon reading the following aspects, which should not be confused with the claims. Each of the number aspects described below can in some instances be combined with one or more additional aspects described below as well as with one of more of the aforementioned aspects of the disclosure.

Aspect 1. A method for driving a display matrix for driving a reflective display from a first display state to a second display state, the reflective display having a plurality of display elements, wherein each of the display elements in the plurality of display elements includes an actuator configured to modify a color of the display element upon actuation; the display matrix having a plurality of row electrodes and a plurality of column electrodes, wherein each of the display elements in the plurality of display elements is coupled to a single row electrode in the plurality of row electrodes and a single column electrode in the plurality of column electrodes; the method including: (i) for each display element in the plurality of display elements, applying a fixed voltage across the actuator for an amount of time to drive the display element from a first color state to a second color state; and repeating step (i) for each display element in the plurality of display elements to drive the display from the first display state to a second display state.

Aspect 2. The method according to any one of Aspects 1-10, wherein the method includes: (a) for a row electrode in the plurality of row electrodes, applying the scanning voltage to the row electrode for an amount of time equal to a line scan time, the cumulative time the scanning voltage is applied to all row electrodes being a frame; (b) for each display element being updated in the frame, applying a selection voltage to the column electrode corresponding to the display element for the amount of time to drive the display element from the first color state to the second color state; (c) repeating steps (a) and (b) for each row electrode in the plurality of row electrodes.

Aspect 3. The method according to any one of Aspects 1-10, wherein a waveform needed to drive the display from the first display state to the second display state is dependent only on the second display state.

Aspect 4. The method according to any one of Aspects 1-10, wherein the display elements have state dependence such that the selection time to drive a display element from a first color state to a second color state is dependent upon the first color state; and wherein a waveform needed to drive the display from the first display state to the second display state includes drive times based upon both the first display state and the second display state.

Aspect 5. The method according to any one of Aspects 1-10, wherein the selection time to drive a display element from a first color state to a second color state is dependent upon an ambient temperature, pressure, and humidity at the display; and wherein a waveform needed to drive the display from the first display state to the second display state includes drive times based upon the ambient temperature, pressure, and humidity.

Aspect 6. The method according to any one of Aspects 1-10, wherein the amount of time each display element is selected is varied by pulse width modulation to apply the selection voltage for the amount of time to drive each display element from each display element's first color state to each display element's second color state.

Aspect 7. The method according to any one of Aspects 1-10, wherein the display is a reflective display based on moving colored inks into and out of the viewable area of each display element.

Aspect 8. The method according to Aspects 1-10, wherein the display comprises a display described in PCT/US2019/058196.

Aspect 9. The method according to Aspects 1-10, wherein each display element further includes a valve to prevent ink from draining from the viewable area while power is removed from the display element.

Aspect 10. The method according to any one of Aspects 1-9, wherein the method further includes applying a waveform to drive the actuators in the opposite direction to that of opening to seal the valve and retain the display element in the second display state.

Aspect 11. A method of driving a reflective display from a first display state to a second display state, the method including generating a waveform for each frame in a number of frames, wherein the waveform represents a drive voltage to be applied to an actuator in each of one or more subpixels; applying the drive voltage to each of the actuators according to the waveform, wherein the subpixels form a plurality of pixels and applying the drive voltage to each of the actuators drives the pixels in the plurality of pixels from a first color state to an intermediate color state; wherein driving each of the pixels over a number of frames, the method transforms the display from the first color state to the second color state; wherein the drive voltage for an actuator commanded by one frame of the waveform may differ from the drive voltage commanded for that same actuator by the next frame.

Aspect 12. The method according to any one of Aspects 11-19, wherein the drive voltage is switched between a zero voltage state and a high voltage state, wherein a difference between the zero voltage state and the high voltage state is greater than a threshold voltage necessary to actuate an actuator in the one or more subpixels.

Aspect 13. The method according to any one of Aspects 11-19, wherein the display comprises a passive matrix display; wherein each frame comprises a number of subframes, each subframe in the number of subframes corresponding to a period of time during which a row in the number of rows is in a high voltage state; wherein, for each subframe, the drive time for the actuator in each subpixel of that row is determined by a percentage of the subframe that a column corresponding to the subpixel is in a zero voltage state.

Aspect 14. The method according to any one of Aspects 11-19, wherein the period of time during which a row is in a high voltage state is the same for each row in the number of rows.

Aspect 15. The method according to any one of Aspects 11-19, wherein the actuator in each of the one or more subpixels is selected from the group consisting of a piezoelectric actuator, an electrostrictive actuator, an electromagnetic actuator, an electrostatic actuator, a hydraulic actuator, a thermal actuator, a chemical actuator, a thermal actuator, and a pneumatic actuator.

Aspect 16. The method according to any one of Aspects 11-19, wherein the display comprises a reflective display based on moving colored inks into and out of the viewable area of each display element.

Aspect 17. The method according to any one of Aspects 11-19, wherein the display comprises a display described in PCT/US2019/058196.

Aspect 18. The method according to any one of Aspects 11-19, wherein each subpixel further comprises a valve to prevent ink from draining from the viewable area while power is removed from the actuator.

Aspect 19. The method according to any one of Aspects 11-18, wherein the method further comprises applying a waveform to drive the actuators in the opposite direction to that of opening to seal the valve and retain the subpixel in the second color state.

Aspect 20. A reflective display device comprising: (i) a plurality of pixels, each of the pixels in the plurality of pixels comprising one or more subpixels and an actuator for independently driving each of the one or more subpixels; (ii) a timing generator that divides a display update time into a number of frames based at least in part on a number of rows and a number of columns in the plurality of pixels; (iii) a waveform generator that generates a waveform for each frame in a number of frames, wherein the waveform represents a drive time for a drive voltage to be applied to an actuator in each of one or more subpixels; wherein applying the drive voltage to the actuators in each of the subpixels according to the waveform drives the display from a first display state to a second display state.

Aspect 21. The reflective display according to any one of Aspects 20-28, wherein the drive voltage is switched between a zero voltage state and a high voltage state, wherein a difference between the zero voltage state and the high voltage state is greater than a threshold voltage necessary to actuate an actuator in the one or more subpixels.

Aspect 22. The reflective display according to any one of Aspects 20-28, wherein the display comprises a passive matrix display; wherein each frame comprises a number of subframes, each subframe in the number of subframes corresponding to a period of time during which a row in the number of rows is in a high voltage state; wherein, for each subframe, the drive time for the actuator in each subpixel of that row is determined by a percentage of the subframe that a column corresponding to the subpixel is in a zero voltage state.

Aspect 23. The reflective display according to any one of Aspects 20-28, wherein the period of time during which a row is in a high voltage state is the same for each row in the number of rows.

Aspect 24. The reflective display according to any one of Aspects 20-28, wherein the actuator in each of the one or more subpixels is selected from the group consisting of a piezoelectric actuator, an electrostrictive actuator, an electromagnetic actuator, an electrostatic actuator, a hydraulic actuator, a thermal actuator, a chemical actuator, and a pneumatic actuator.

Aspect 25. The reflective display according to any one of Aspects 20-28, wherein the display comprises a reflective display based on moving colored inks into and out of the viewable area of each subpixel.

Aspect 26. The reflective display according to any one of Aspects 20-28, wherein the display comprises a display described in PCT/US2019/058196.

Aspect 27. The reflective display according to any one of Aspects 20-28, wherein each display element further comprises a valve to prevent ink from draining from the viewable area while power is removed from the subpixels.

Aspect 28. The reflective display according to any one of Aspects 20-27, wherein the method further comprises applying a waveform to drive the actuators in the opposite direction to that of opening to seal the valve and retain the subpixel in the second color state.

Aspect 29. A reflective display comprising a display matrix comprising a plurality of row electrodes and a plurality of column electrodes, a plurality of display elements, wherein each of the display elements in the plurality of display elements comprise an actuator configured to modify a color of the display element upon actuation, and wherein each of the display elements in the plurality of display elements is coupled to a single row electrode in the plurality of row electrodes and a single column electrode in the plurality of column electrodes; a voltage source for applying a fixed voltage to each of the row electrodes and column electrodes in the plurality of electrodes; and a waveform generator for determining an amount of time to apply the fixed voltage to each display element to drive the display element from a first color state to a second color state.

Aspect 30. The reflective display according to any one of Aspects 29-34, wherein the voltage source is configured to apply a scanning voltage to a row electrode for an amount of time equal to a scan time, the amount of time the scanning voltage is applied to the row electrode being a frame.

Aspect 31. The reflective display according to any one of Aspects 29-34, wherein the voltage source is configured to apply a selection voltage to the column electrode corresponding to each display element for the amount of time to drive the display element from the first color state to the second color state.

Aspect 32. The reflective display according to any one of Aspects 29-34, wherein the display comprises a reflective display based on moving colored inks into and out of the viewable area of each display element.

Aspect 33. The reflective display according any one of Aspects 29-34, wherein the display comprises a display described in PCT/US2019/058196.

Aspect 34. The reflective display according to any one of Aspects 29-33, wherein each display element further comprises a valve to prevent ink from draining from the viewable area while power is removed from the display element.

Aspect 35. The method according to any one of Aspects 1-19 and 35-66 or the reflective display according to any one of Aspects 20-66, wherein the display device is configured to alter an optical property by moving an amount of a first fluid through which external light can pass, the display device comprising: a fluidic display unit comprising at least a first cavity comprising a first fluid, the first fluid movable within the first cavity by varying an amount of pressure on the first cavity; and a fluidic actuator mechanically coupled to the fluid-filled cavity of the fluidic display unit, the fluidic actuator comprising a second fluid, wherein the fluidic actuator is configured to be electrically actuated to vary the amount of pressure on the first cavity of the fluidic display unit, wherein varying the pressure causes movement of the first fluid within the fluidic display unit, thereby altering the optical property of the display.

Aspect 36. The method according to any one of Aspects 1-19 and 35-66 or the reflective display according to any one of Aspects 20-66, wherein the first fluid is chosen from an ink, a dye, a pigment, a solution of any of the foregoing, and a combination thereof.

Aspect 37. The method according to any one of Aspects 1-19 and 35-66 or the reflective display according to any one of Aspects 20-66, wherein the fluidic actuator comprises at least one dielectric elastomer.

Aspect 38. The method according to any one of Aspects 1-19 and 35-66 or the reflective display according to any one of Aspects 20-66, wherein the dielectric elastomer comprises a passive elastomer film sandwiched between two electrodes.

Aspect 39. The method according to any one of Aspects 1-19 and 35-66 or the reflective display according to any one of Aspects 20-66, wherein the elastomer is chosen from polyacrylate elastomer, natural rubber, silicone rubber, chloroprene rubber, butyl rubber, isoprene rubber, nitrile rubber, ethylene propylene diene monomer (EPDM), acrylonitrile butadiene styrene (ABS), fluorosilicone, thermoplastic elastomer, poly(urethane) rubber, copolymers of any of the aforementioned elastomers, composites of the aforementioned with at least one inorganic filler, and combinations thereof.

Aspect 40. The method according to any one of Aspects 1-19 and 35-66 or the reflective display according to any one of Aspects 20-66, wherein the fluidic actuator further comprises electrodes attached to opposing sides of the dielectric elastomer, and wherein varying an electric potential applied across the electrodes varies the amount of pressure applied to the fluid-filled cavity of the fluidic display unit.

Aspect 41. The method according to any one of Aspects 1-19 and 35-66 or the reflective display according to any one of Aspects 20-66, wherein the fluidic actuator is configured to apply a plurality of different pressures to the fluid-filled cavity of the fluidic display unit, and wherein operating the actuator to switch from producing a first pressure of the plurality of different pressures to a second pressure of the plurality of different pressures causes the movement of the first fluid within the fluidic display unit.

Aspect 42. The method according to any one of Aspects 1-19 and 35-66 or the reflective display according to any one of Aspects 20-66, wherein the second fluid is chosen from aqueous salt solutions, glycerin, glycols, polyols, silicone oils, vegetable oils, mineral oils, motor oils, lubricating oils, polyalphaolefins, ionic liquids, hydrofluoroethers, fluoroketones, silicate esters, synthetic oils, fluorinated hydrocarbons, and combinations thereof.

Aspect 43. The method according to any one of Aspects 1-19 and 35-66 or the reflective display according to any one of Aspects 20-66, wherein the second fluid is pressurized within the fluidic actuator at a higher pressure than the first fluid is pressurized within the fluidic display unit.

Aspect 44. The method according to any one of Aspects 1-19 and 35-66 or the reflective display according to any one of Aspects 20-66, further comprising a plurality of fluidic display units each corresponding to a pixel or sub-pixel of the display and each mechanically coupled to respective fluidic actuators.

Aspect 45. The method according to any one of Aspects 1-19 and 35-66 or the reflective display according to any one of Aspects 20-66, wherein the fluidic display unit comprises a second cavity and a reflective layer arranged between the first cavity and the second cavity.

Aspect 46. The method according to any one of Aspects 1-19 and 35-66 or the reflective display according to any one of Aspects 20-66, wherein the fluidic actuator comprises: a first cavity comprising the second fluid and bounded at least in part by a first elastomer; a second cavity comprising the second fluid and bounded at least in by part by a second elastomer; a channel connecting the first cavity to the second cavity and through which the second fluid can flow; and a valve configured to be electrically operated into an open state or a closed state and thereby allow or block a flow of the second fluid through the channel, respectively, wherein maintaining the valve in the closed state requires less electrical power than maintaining the valve in the open state.

Aspect 47. The method according to any one of Aspects 1-19 and 35-66 or the reflective display according to any one of Aspects 20-66, wherein the display unit further comprises one or more reflectors such that visible light can pass through at least a portion of the fluidic display unit, be reflected from the reflector, and be output from the display unit in a viewing direction; wherein the optical property is a color of the visible light output from the display unit; wherein the fluidic actuator comprises a first cavity comprising fluid and bounded at least in part by a first elastomer; a second cavity comprising fluid and bounded at least in by part by a second elastomer; a channel connecting the first cavity to the second cavity and through which fluid can flow; and a valve configured to be electrically operated into an open state or a closed state and thereby allow or block flow of the fluid through the channel, respectively, wherein maintaining the valve in the closed state requires less electrical power than maintaining the valve in the open state; and wherein the first fluid is chosen from an ink, a dye, a pigment, a solution of any of the foregoing, and a combination thereof.

Aspect 48. The method according to any one of Aspects 1-19 and 35-66 or the reflective display according to any one of Aspects 20-66, wherein the display unit further comprises one or more sources of visible light configured such that a visible light can pass through at least a portion of the fluidic display unit and be output from the display unit in a viewing direction; wherein the optical property is a color of the visible light output from the display unit; wherein the fluidic actuator comprises a first cavity comprising fluid and bounded at least in part by a first elastomer; a second cavity comprising fluid and bounded at least in by part by a second elastomer; a channel connecting the first cavity to the second cavity and through which fluid can flow; and a valve configured to be electrically operated into an open state or a closed state and thereby allow or block flow of the fluid through the channel, respectively, wherein maintaining the valve in the closed state requires less electrical power than maintaining the valve in the open state; and wherein the first fluid is chosen from an ink, a dye, a pigment, a solution of any of the foregoing, and a combination thereof.

Aspect 49. The method according to any one of Aspects 1-19 and 35-66 or the reflective display according to any one of Aspects 20-66, wherein the actuator comprises a first cavity comprising fluid and bounded at least in part by a first elastomer; a second cavity comprising fluid and bounded at least in by part by a second elastomer; a channel connecting the first cavity to the second cavity and through which fluid can flow; and a valve configured to be electrically operated into an open state or a closed state and thereby allow or block flow of the fluid through the channel, respectively, wherein maintaining the valve in the closed state requires less electrical power than maintaining the valve in the open state.

Aspect 50. The method according to any one of Aspects 1-19 and 35-66 or the reflective display according to any one of Aspects 20-66, wherein maintaining the valve in the closed state requires no electrical power.

Aspect 51. The method according to any one of Aspects 1-19 and 35-66 or the reflective display according to any one of Aspects 20-66, the actuator further comprising electrodes attached to opposing sides of the first elastomer, and wherein applying an electric potential across the electrodes alters the first elastomer's shape and causes fluid to flow from the second cavity into the first cavity via the channel.

Aspect 52. The method according to any one of Aspects 1-19 and 35-66 or the reflective display according to any one of Aspects 20-66, wherein the valve is configured to be electrically operated into at least three states which include the open state and the closed state.

Aspect 53. The method according to any one of Aspects 1-19 and 35-66 or the reflective display according to any one of Aspects 20-66, wherein the fluid of the first and second cavities comprises a dielectric oil.

Aspect 54. The method according to any one of Aspects 1-19 and 35-66 or the reflective display according to any one of Aspects 20-66, wherein: the valve comprises a flap arranged to move about at least one axis; the actuator comprises at least a first electrode proximate to the flap; and the actuator is configured to electrically charge the first electrode, thereby attracting the flap towards the first electrode and operating the valve into the open state.

Aspect 55. The method according to any one of Aspects 1-19 and 35-66 or the reflective display according to any one of Aspects 20-66, wherein the actuator comprises a second electrode and the actuator is configured to electrically charge the second electrode, thereby attracting the flap towards the second electrode and operating the valve into the closed state.

Aspect 56. The method according to any one of Aspects 1-19 and 35-66 or the reflective display according to any one of Aspects 20-66, wherein the flap is arranged over an opening of the channel and extends beyond at least one dimension of the opening such that the flap cannot pass through the opening.

Aspect 57. The method according to any one of Aspects 1-19 and 35-66 or the reflective display according to any one of Aspects 20-66, wherein the valve comprises a third cavity comprising fluid and bounded at least in part by a dielectric elastomer, the dielectric elastomer comprising electrodes attached to opposing sides of a third elastomer; wherein the third cavity is arranged proximate to an opening of the channel; and wherein applying a first electric potential across the electrodes attached to the third elastomer alters the third elastomer's shape and causes the third cavity to allow fluid to flow through the opening of the channel.

Aspect 58. The method according to any one of Aspects 1-19 and 35-66 or the reflective display according to any one of Aspects 20-66, wherein applying a second electric potential across the electrodes attached to the third elastomer, the second electric potential being lower than the first electric potential, causes the third cavity to block fluid from flowing through the opening of the channel.

Aspect 59. The method according to any one of Aspects 1-19 and 35-66 or the reflective display according to any one of Aspects 20-66, wherein maintaining the second electric potential across the electrodes attached to the third elastomer requires no power.

Aspect 60. The method according to any one of Aspects 1-19 and 35-66 or the reflective display according to any one of Aspects 20-66, wherein the display device is configured to alter an optical property by moving an amount of a first fluid through which external light can pass, the display device comprising: a fluidic display unit comprising at least a first cavity comprising a first fluid, the first fluid movable within the first cavity by varying an amount of pressure on the first cavity; and a means of electrically varying the amount of pressure on the first cavity of the fluidic display unit, wherein varying the pressure causes movement of the first fluid within the fluidic display unit, thereby altering the optical property of the display.

Aspect 61. The method according to any one of Aspects 1-19 and 35-66 or the reflective display according to any one of Aspects 20-66, wherein the means of electrically varying the amount of pressure comprises at least one dielectric elastomer.

Aspect 62. The method according to any one of Aspects 1-19 and 35-66 or the reflective display according to any one of Aspects 20-66, wherein the dielectric elastomer comprises a passive elastomer film sandwiched between two electrodes.

Aspect 63. The method according to any one of Aspects 1-19 and 35-66 or the reflective display according to any one of Aspects 20-66, wherein the elastomer is chosen from polyacrylate elastomer, natural rubber, silicone rubber, chloroprene rubber, butyl rubber, isoprene rubber, nitrile rubber, ethylene propylene diene monomer (EPDM), acrylonitrile butadiene styrene (ABS), fluorosilicone, thermoplastic elastomer, poly(urethane) rubber, copolymers of any of the aforementioned elastomers, composites of the aforementioned with at least one inorganic filler, and combinations thereof.

Aspect 64. The method according to any one of Aspects 1-19 and 35-66 or the reflective display according to any one of Aspects 20-66, wherein the means of electrically varying the amount of pressure further comprises electrodes attached to opposing sides of the dielectric elastomer, and wherein varying an electric potential applied across the electrodes varies the amount of pressure applied to the fluid-filled cavity of the fluidic display unit.

Aspect 65. The method according to any one of Aspects 1-19 and 35-66 or the reflective display according to any one of Aspects 20-66, wherein the means of electrically varying the amount of pressure is configured to apply a plurality of different pressures to the fluid-filled cavity of the fluidic display unit, and wherein operating the actuator to switch from producing a first pressure of the plurality of different pressures to a second pressure of the plurality of different pressures causes the movement of the first fluid within the fluidic display unit.

Aspect 66. The method according to any one of Aspects 1-19 and 35-66 or the reflective display according to any one of Aspects 20-66, wherein the means of electrically varying the amount of pressure comprises an actuator according to any one of Aspects 15-25.

It should be emphasized that the above-described aspects of the present disclosure are merely possible examples of implementations, and are set forth only for a clear understanding of the principles of the disclosure. Many variations and modifications may be made to the above-described aspects of the disclosure without departing substantially from the spirit and principles of the disclosure. All such modifications and variations are intended to be included herein within the scope of this disclosure.

1. A method for driving a display matrix for driving a reflective display from a first display state to a second display state,
the reflective display comprising a plurality of display elements, wherein each of the display elements in the plurality of display elements comprise an actuator configured to modify a color of the display element upon actuation;
the display matrix comprising a plurality of row electrodes and a plurality of column electrodes, wherein each of the display elements in the plurality of display elements is coupled to a single row electrode in the plurality of row electrodes and a single column electrode in the plurality of column electrodes;
the method comprising:
(i) for each display element in the plurality of display elements, applying a fixed voltage across the actuator for an amount of time to drive the display element from a first color state to a second color state; and
repeating step (i) for each display element in the plurality of display elements to drive the display from the first display state to a second display state,
wherein a selection time to drive a display element from a first color state to a second color state is dependent upon an ambient temperature, pressure, and humidity at the display; and
wherein a waveform needed to drive the display from the first display state to the second display state includes drive times based upon the ambient temperature, pressure, and humidity.

2. The method according to claim 1, wherein the method comprises:
(a) for a row electrode in the plurality of row electrodes, applying the scanning voltage to the row electrode for an amount of time equal to a line scan time, the cumulative time the scanning voltage is applied to all row electrodes being a frame;
(b) for each display element being updated in the frame, applying a selection voltage to the column electrode corresponding to the display element for the amount of time to drive the display element from the first color state to the second color state;
(c) repeating steps (a) and (b) for each row electrode in the plurality of row electrodes.

3. The method according to claim 1, wherein a waveform needed to drive the display from the first display state to the second display state is dependent only on the second display state.

4. The method according to claim 1, wherein the display elements have state dependence such that the selection time to drive a display element from a first color state to a second color state is dependent upon the first color state; and
wherein a waveform needed to drive the display from the first display state to the second display state includes drive times based upon both the first display state and the second display state.

5. (canceled)

6. The method according to claim 1, wherein the amount of time each display element is selected is varied by pulse width modulation to apply the selection voltage for the amount of time to drive each display element from each display element's first color state to each display element's second color state.

7. The method according to claim 1, wherein the display comprises a reflective display based on moving colored inks into and out of the viewable area of each display element.

8. The method according to claim 7, wherein the display comprises a display that is configured to alter an optical property by moving an amount of a first fluid through which external light can pass, the display device comprising: a fluidic display element comprising at least a first cavity comprising a first fluid, the first fluid movable within the first cavity by varying an amount of pressure on the first cavity; wherein the actuator provides a means of electrically varying the amount of pressure on the first cavity of the fluidic display unit, wherein varying the pressure causes movement of the first fluid within the fluidic display unit, thereby altering the optical property of the display.

9. The method according to claim 8, wherein each display element further comprises a valve to prevent ink from draining from the viewable area while power is removed from the display element.

10. The method according to claim 9, wherein the method further comprises applying a waveform to drive the actuators in the opposite direction to that of opening to seal the valve and retain the display element in the second display state.

11. A method of driving a reflective display from a first display state to a second display state, the method comprising:
generating a waveform for each frame in a number of frames, wherein the waveform represents a drive voltage to be applied to an actuator in each of one or more subpixels;
applying the drive voltage to each of the actuators according to the waveform, wherein the subpixels form a plurality of pixels and applying the drive voltage to each of the actuators drives the pixels in the plurality of pixels from a first color state to an intermediate color state;
wherein driving each of the pixels over a number of frames, the method transforms the display from the first color state to the second color state;
wherein the drive voltage for an actuator commanded by one frame of the waveform may differ from the drive voltage commanded for that same actuator by the next frame,
wherein the waveform for each frame in the number of frames includes drive times for applying the drive voltage based upon ambient temperature, pressure, and humidity at the reflective display.

12. The method according to claim 11, wherein the drive voltage is switched between a zero voltage state and a high voltage state, wherein a difference between the zero voltage state and the high voltage state is greater than a threshold voltage necessary to actuate an actuator in the one or more subpixels.

13. The method according to claim 11, wherein the display comprises a passive matrix display;
wherein each frame comprises a number of subframes, each subframe in the number of subframes corresponding to a period of time during which a row in the number of rows is in a high voltage state;
wherein, for each subframe, the drive time for the actuator in each subpixel of that row is determined by a percentage of the subframe that a column corresponding to the subpixel is in a zero voltage state.

14. The method according to claim 13, wherein the period of time during which a row is in a high voltage state is the same for each row in the number of rows.

15. The method according to claim 13, wherein the actuator in each of the one or more subpixels is selected from the group consisting of a piezoelectric actuator, an electrostrictive actuator, an electromagnetic actuator, an electrostatic actuator, a hydraulic actuator, a thermal actuator, a chemical actuator, a thermal actuator, and a pneumatic actuator.

16. The method according to claim 13, wherein the display comprises a reflective display based on moving colored inks into and out of the viewable area of each display element.

17. The method according to claim 16, wherein the display comprises a display that is configured to alter an optical property by moving an amount of a first fluid through which external light can pass, the display device comprising: a fluidic display element comprising at least a first cavity comprising a first fluid, the first fluid movable within the first cavity by varying an amount of pressure on the first cavity; wherein the actuator provides a means of electrically varying the amount of pressure on the first cavity of the fluidic display unit, wherein varying the pressure causes movement of the first fluid within the fluidic display unit, thereby altering the optical property of the display.

18. The method according to claim 17, wherein each subpixel further comprises a valve to prevent ink from draining from the viewable area while power is removed from the actuator.

19. The method according to claim 18, wherein the method further comprises applying a waveform to drive the actuators in the opposite direction to that of opening to seal the valve and retain the subpixel in the second color state.

20. A reflective display device comprising:
(i) a plurality of pixels, each of the pixels in the plurality of pixels comprising one or more subpixels and an actuator for independently driving each of the one or more subpixels;
(ii) a timing generator that divides a display update time into a number of frames based at least in part on a number of rows and a number of columns in the plurality of pixels;
(iii) a waveform generator that generates a waveform for each frame in a number of frames, wherein the waveform represents a drive time for a drive voltage to be applied to an actuator in each of one or more subpixels;
wherein applying the drive voltage to the actuators in each of the subpixels according to the waveform drives the display from a first display state to a second display state,
wherein the waveform represents the drive time based in part upon an ambient temperature, pressure, and humidity at the reflective display.

21.-33. (canceled)
